(19) United States
(12) Patent Application Publication
(10) Pub. No.: US 2026/0153594 A1
(43) Pub. Date: Jun. 4, 2026

(54) VEHICLE RADAR UNIT

(71) Applicant: TOYODA GOSEI CO., LTD., Kiyosu-shi (JP)

(72) Inventors: Shunsuke AOYAMA, Kiyosu-shi (JP); Koji OKUMURA, Kiyosu-shi (JP); Akiko KIMURA, Kiyosu-shi (JP); Kozo HIROTANI, Kiyosu-shi (JP)

(21) Appl. No.: 19/400,098

(22) Filed: Nov. 25, 2025

(30) Foreign Application Priority Data
Dec. 3, 2024 (JP) 2024-209939

(51) Int. Cl. G01S 7/02; B60Q 1/00; B60R 13/00

(52) U.S. Cl. CPC G01S 7/028; B60Q 1/0023; B60R 13/005

(57) ABSTRACT

A vehicle radar unit includes a radar device emitting and receiving electromagnetic waves, and an exterior member. The exterior member includes a light source, a housing including an opening, and a cover covering the opening. The housing includes a bottom wall and an outer wall. The bottom wall includes a projection including an inner wall extending rearward in the emitting direction from an edge of a projection end. The radar device is located at a position separated from the inner wall in a direction orthogonal to a central axis extending through a center of the radar device. An inclination angle of the inner wall, a length of the inner wall, and a shortest distance from the central axis to the inner wall are set so that a tilted angle of a main lobe of the electromagnetic waves is more than 0° and not more than 0.38° in absolute value.

### CROSS-REFERENCE TO RELATED APPLICATIONS

This application is based upon and claims the benefit of priority from Japanese Patent Application No. 2024-209939, filed on December 3, 2024, the entire contents of which are incorporated herein by reference.

### BACKGROUND

### 1. Field

The present disclosure relates to a vehicle radar unit.

### 2. Description of Related Art

WO2020/179577A discloses an emblem unit for a vehicle. The emblem unit includes an emblem, an emblem lamp (hereinafter, “lamp”), and an emblem attachment sensor (hereinafter, “sensor”). The emblem is attached to the front portion of the vehicle. The lamp includes a light guide, an emblem light source (hereinafter, “light source”), and a reflector. The light guide is arranged in the rear portion of the emblem. The light source faces a light receiving portion arranged in the outer surface of the light guide. The reflector is formed on the rear surface of the light guide. The sensor is located in the rear portion of the light guide. The sensor emits millimeter waves toward the front of the vehicle and receives the reflected waves to obtain frontward information of the vehicle.

In such an emblem unit, the light from the light receiving portion entering the light guide is repeatedly reflected by the reflector and by the inside of the light guide. Then, the light is emitted forward from the front surface of the emblem. Further, the millimeter waves emitted from the sensor, which is arranged on the rear surface of the light guide, are transmitted forward through the light guide and the emblem.

The emblem unit described in the above publication is attached to a front grille of the vehicle by a bracket.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In such an emblem unit, the sensor is surrounded by the bracket. Thus, the size and the arrangement of the sensor are limited by the size of the bracket.

Accordingly, the sensor may be located at a position separated from the rear surface of the light guide so that the sensor is not surrounded by the bracket. The radio waves emitted from the sensor, however, include a main lobe and side lobes or the like, which are radio waves transmitted in directions differing from the main lobe. Thus, when the sensor is located at a position separated from the rear surface of the light guide, for example, side lobes are more likely to strike the inner surface of the bracket. When the side lobes strike the inner surface of the bracket, the side lobes are reflected by the inner surface, and the reflected side lobes interfere with the main lobe. As a result, the propagation direction of the main lobe will be tilted from the transmission direction. This effect, which is referred to as a beam tilt, may adversely affect the accuracy of the sensor. In this manner, it is difficult to improve the degree of design freedom of the sensor while ensuring the accuracy of the sensor.

Such an issue is not limited to emblem units attached to vehicles by brackets but also applies to a radar unit including a radar device and an exterior member that is arranged in front of the radar device and surrounds the radar device.

In one general aspect, a vehicle radar unit includes a radar device configured to emit and receive electromagnetic waves and an exterior member, having electromagnetic wave transmissivity, arranged in front of the radar device in an emitting direction of the electromagnetic waves. The exterior member includes a light source configured to emit visible light, a housing including an opening that is open frontward in the emitting direction, and a cover having visible light transmittivity and covering the opening. The housing includes a bottom wall and an outer wall extending frontward in the emitting direction from an edge of the bottom wall. The bottom wall includes a projection projecting in the emitting direction and separated from the radar device, the projection and the outer wall forming an accommodation portion for accommodation of the light source. The projection includes an inner wall extending rearward in the emitting direction from an edge of a projection end. The radar device is located at a position separated from the inner wall in a direction orthogonal to a central axis extending in the emitting direction through a center of the radar device. An inclination angle of the inner wall with respect to the central axis, a length of the inner wall in the emitting direction, and a shortest distance from the central axis to the inner wall are set so that a tilted angle of a main lobe of the electromagnetic waves emitted from the radar device with respect to the central axis is greater than 0° and less than or equal to 0.38° in absolute value.

Other features and aspects will be apparent from the following detailed description, the drawings, and the claims.

### BRIEF DESCRIPTION OF THE DRAWINGS

FIG. 1 is a front view showing an embodiment of a vehicle radar unit.

FIG. 2 is a cross-sectional view taken along line 2-2 in FIG. 1.

FIG. 3 is a schematic diagram illustrating the dimensions of the vehicle radar unit in the embodiment.

FIG. 4 is a graph illustrating the relationship between the inclination angle of an inner wall of a housing and a tilted angle of a main lobe.

FIG. 5 is a graph illustrating the relationship between the length of the inner wall of the housing and the tilted angle of the main lobe.

FIG. 6 is a graph illustrating the relationship between the shortest distance from a central axis of the radar device to the inner wall of the housing and the tilted angle of the main lobe.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

An embodiment of a vehicle radar unit will now be described with reference to FIGS. 1 to 6. Hereinafter, the longitudinal direction of the vehicle will be referred to as the longitudinal direction X. The front side and the rear side in the longitudinal direction X are simply referred to as the front and the rear. Further, the lateral direction of the vehicle will be referred to as the lateral direction W. When the vehicle is located on level ground, the vertical direction of the vehicle will be referred to as the vertical direction Z.

### Basic Structure of Vehicle Radar Unit

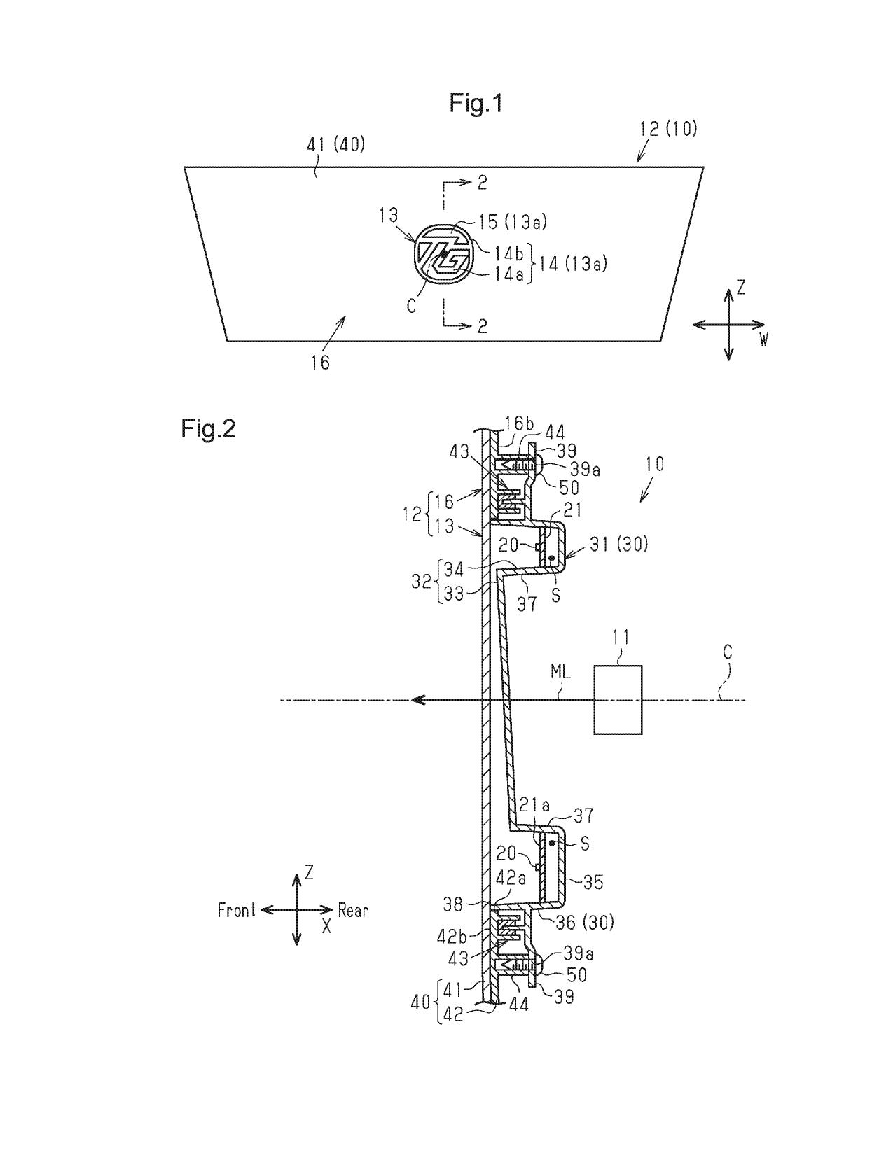

As shown in FIGS. 1 and 2, a vehicle radar unit 10 includes a radar device 11 and an exterior member 12 arranged in front of the radar device 11.

The radar device 11 is an on-board sensor that detects an object located outside the vehicle by emitting electromagnetic waves and receiving the electromagnetic waves reflected by the object. The radar device 11 emits, for example, electromagnetic waves, more specifically, millimeter waves having a wavelength of 1 mm to 10 mm and a frequency of 30 GHz to 300 GHz. In the present embodiment, the radar device 11 is attached to the front portion of the vehicle so as to emit the millimeter waves forward. In other words, the transmission direction of the electromagnetic waves (millimeter waves) of the radar device 11 coincides with the longitudinal direction X of the vehicle. FIG. 2 schematically shows a main lobe ML of the millimeter waves emitted from the radar device 11.

The exterior member 12 forms a part of the exterior body of the vehicle in a front portion of the vehicle. The exterior member 12 is a rectangular plate elongated in the lateral direction W (refer to FIG. 1). The exterior member 12 includes an emblem 13 and a panel 16, which is the part other than the emblem 13. The emblem 13 has electromagnetic wave (millimeter wave) transmissivity and is located in front of the radar device 11. Further, the emblem 13 is located in the central part of the exterior member 12. More specifically, the central portion of the emblem 13 in the present embodiment is aligned with a central axis C. The central axis C extends along the longitudinal direction X and through the center of the radar device 11 (refer to FIG. 2). In the following description, with respect to the radial direction extending about the central axis C, the direction extending toward the center axis C may be referred to as the inner direction, and the direction extending away from the center axis C may be referred to as the outer direction.

As shown in FIG. 1, the outer shape of an ornamental surface 13a of the emblem 13 is circular as viewed from the front. The ornamental surface 13a includes a display region 14 and a background region 15. The display region 14 displays a mark facing forward, and the background region 15 is the portion that is not the display region 14. The mark may be stylized text (logotype) indicating the manufacturer, model, grade, or the like of the vehicle; a shape (symbol mark) representing the manufacturer of the vehicle, or a logo combining characters and shapes. In the present embodiment, the display region 14 includes a character portion 14a that shows the alphabetic characters “TG” and an annular portion 14b that extends along the edge of the emblem 13 and surrounds the character portion 14a.

As shown in FIGS. 1 and 2, the exterior member 12 includes light sources 20, a housing 30, and a cover 40. Each component will now be described.

### Light Sources

As shown in FIG. 2, the light sources 20 are arranged on a substrate 21. The substrate 21 extends along the edge of the emblem 13. In the present embodiment, the light sources 20 are spaced apart from one another on the substrate 21 in the extending direction of the substrate 21. The light sources 20 are fixed to a front surface 21a of the substrate 21 and emit visible light (hereinafter, “light”) forward. The light sources 20 each include a light-emitting element such as a light-emitting diode (LED).

### Housing

As shown in FIG. 2, the housing 30 includes a bottom wall 31 and an outer wall 36 extending forward from the edge of the bottom wall 31. The bottom wall 31 forms the rear wall of the emblem 13 and faces the radar device 11 in the longitudinal direction X. The bottom wall 31 includes a projection 32 projecting forward and separated from the radar device 11 in the longitudinal direction X, and a general portion 35 located in the outside of the projection 32. The projection 32 includes a flat end portion 33 and an inner wall 34 extending rearward from the edges of the end portion 33. In the present embodiment, the end portion 33 is inclined with respect to the vertical direction Z. The inner wall 34 is inclined outward and toward the rear. The inner wall 34, the general portion 35 and the outer wall 36 form an accommodation portion 37. The accommodation portion 37 includes an accommodation space S where the light sources 20 and the substrate 21 are accommodated. A light guide (not shown) is accommodated in the accommodation portion 37 in front of the light sources 20 to guide the light emitted from the light sources 20 toward the radially inner side of the emblem 13.

An opening 38 at a distal end of the outer wall 36 is open frontward. A flange 39 extends outward from the outer wall 36.

The housing 30 is, for example, formed from resin material in which particles of a white light-diffusing material are dispersed. Thus, the inner surface of the housing 30 acts as a reflection surface, which reflects light. The resin material that forms the housing 30 may be, for example, acrylonitrile butadiene styrene (ABS) resin. An example of the light-diffusing material is a metal oxide such as titanium oxide or zinc oxide.

### Cover

As shown in FIGS. 1 and 2, the cover 40 includes a first cover portion 41 located at the side closer to the ornamental surface 13a, and a second cover portion 42 laminated on the rear surface of the first cover portion 41.

As shown in FIG. 2, the first cover portion 41 covers the opening 38 from the front. The part of the first cover portion 41 that corresponds to the emblem 13 defines a light-transmitting portion (not shown) configured to transmit the light from the light sources 20 and a light-shielding portion (not shown) configured to block the light from the light sources 20. In the present embodiment, the display region 14 is formed by the light transmitting portion. Further, the background region 15 is formed by the light shielding portion.

The second cover portion 42 defines a rear surface 16b of the panel 16 in the cover 40. A hole extending through the part of the second cover portion 42 corresponding to the emblem 13 forms a hole 42a in the longitudinal direction X. The housing 30 is fitted into the hole 42a. Further, the opening edge 42b of the hole 42a includes a seal 43 and bosses 44 arranged in this order from the inner side. For example, the seal 43 may be, for example, a hot melt adhesive or the like is used to restrict the passage of water between the flange 39 and the opening edge 42b. The housing 30 is fixed to the cover 40 by inserting screws 50 into fastening holes 39a formed in the flange 39 and fastening the screws to threaded holes of the bosses 44.

The emblem 13 is configured to illuminate and display the display region 14 forward when the light emitted from the light sources 20 and repeatedly reflected between the housing 30 (particularly, the projection end portion 33) and the first cover portion 41 passes through the light-transmitting portion of the first cover portion 41.

### Dimensions and Arrangement of Each Part of Vehicle Radar Unit

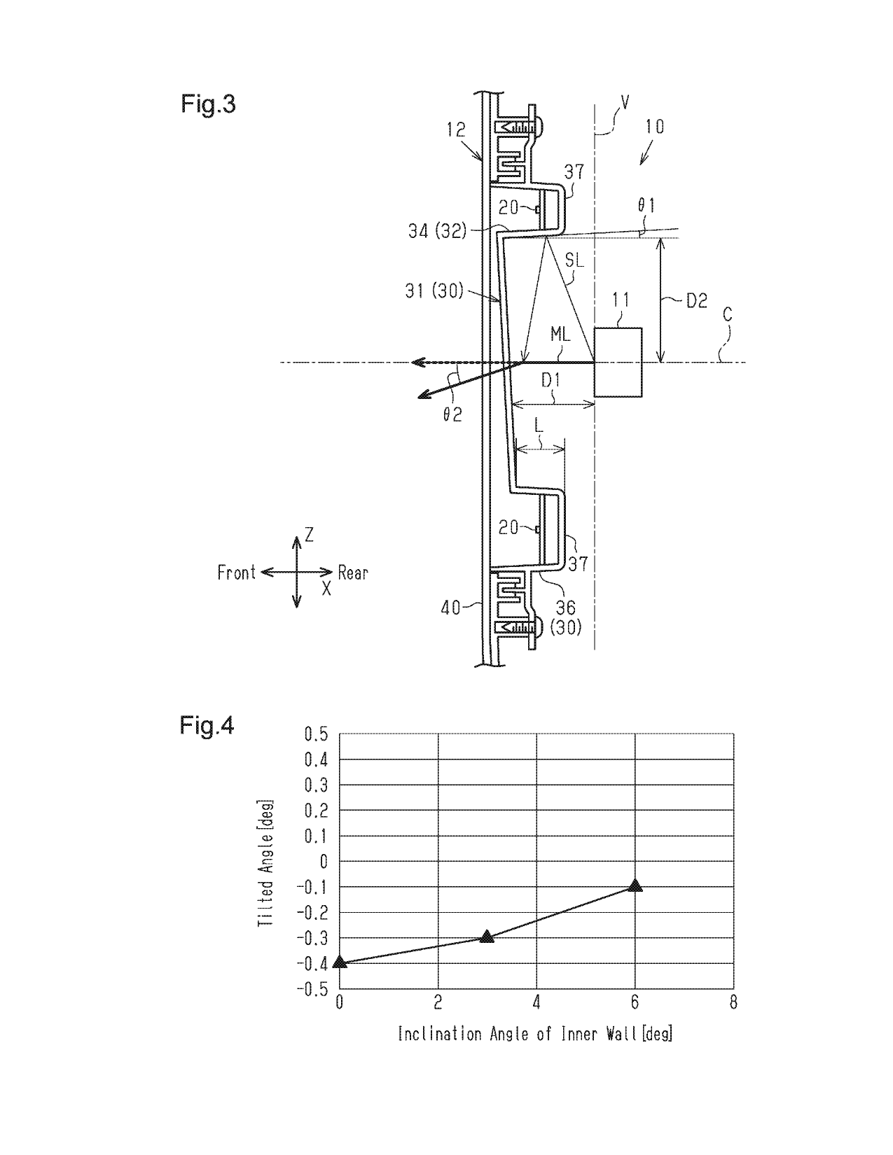

As shown in FIG. 3, the radar device 11 is separated from the inner wall 34 of the accommodation portion 37 in a direction orthogonal to the central axis C. In other words, among imaginary planes orthogonal to the central axis C, the inner wall 34 of the accommodation portion 37 is not located on an imaginary plane V where the radar device 11 is located. Further, in the present embodiment, a distance D1 of 18 mm is set between the radar device 11 and where the bottom wall 31 intersects the central axis C.

The inclination angle θ1 of the inner wall 34 with respect to the central axis C, the length L of the inner wall 34 in the longitudinal direction X, and the shortest distance D2 from the central axis C to the inner wall 34 are set so that an absolute value of a tilted angle θ2 of the main lobe ML, which is emitted from the radar device 11, with respect to the central axis C is greater than 0° and less than or equal to 0.38°. In FIG. 3, broken line shows the main lobe ML when beam tilt does not occur, and the solid line shows the main lobe ML after beam tilt occurs.

The relationship between the inclination angle θ1, the length L, the shortest distance D2, and the tilted angle θ2 will now be described with reference to FIGS. 4 to 6. In strict terms, the tilted angle in each graph is the tilted angle θ2 that is the angle of inclination from 0°, which is the tilted angle of the main lobe ML when the exterior member 12 is not arranged in front of the radar device 11.

The graph in FIG. 4 shows changes in the tilted angle θ2 of the main lobe ML emitted by the radar device 11 when the inclination angle θ1 changes. The tilted angle θ2 becomes closer to 0° as the inclination angle θ1 increases. The increase in the inclination angle θ1 decreases the angle of incidence of the side lobe SL striking the inner wall 34. Thus, the transmission component of the side lobe SL passing through the inner wall 34 becomes larger, and the reflection component of the side lobe SL reflected by the inner wall 34 becomes smaller. Further, when the inclination angle θ1 is less than 1°, the tilted angle θ2 is less than -0.38 °. Thus, in order to set the absolute value of the tilted angle θ2 to less than or equal to 0.38, the inclination angle θ1 is preferably greater than or equal to 1°. As the inclination angle θ1 increases, the housing 30 will have to be enlarged radially outward in order to obtain enough accommodation space S in the accommodation portion 37 for accommodation of the light sources 20. This situation will become particularly prominent when the inclination angle θ1 is greater than 12°. Accordingly, to reduce the size of the housing 30 in the radial direction, it is preferred that the inclination angle θ1 be less than or equal to 12°. In the present embodiment, the inclination angle θ1 is set to 3°.

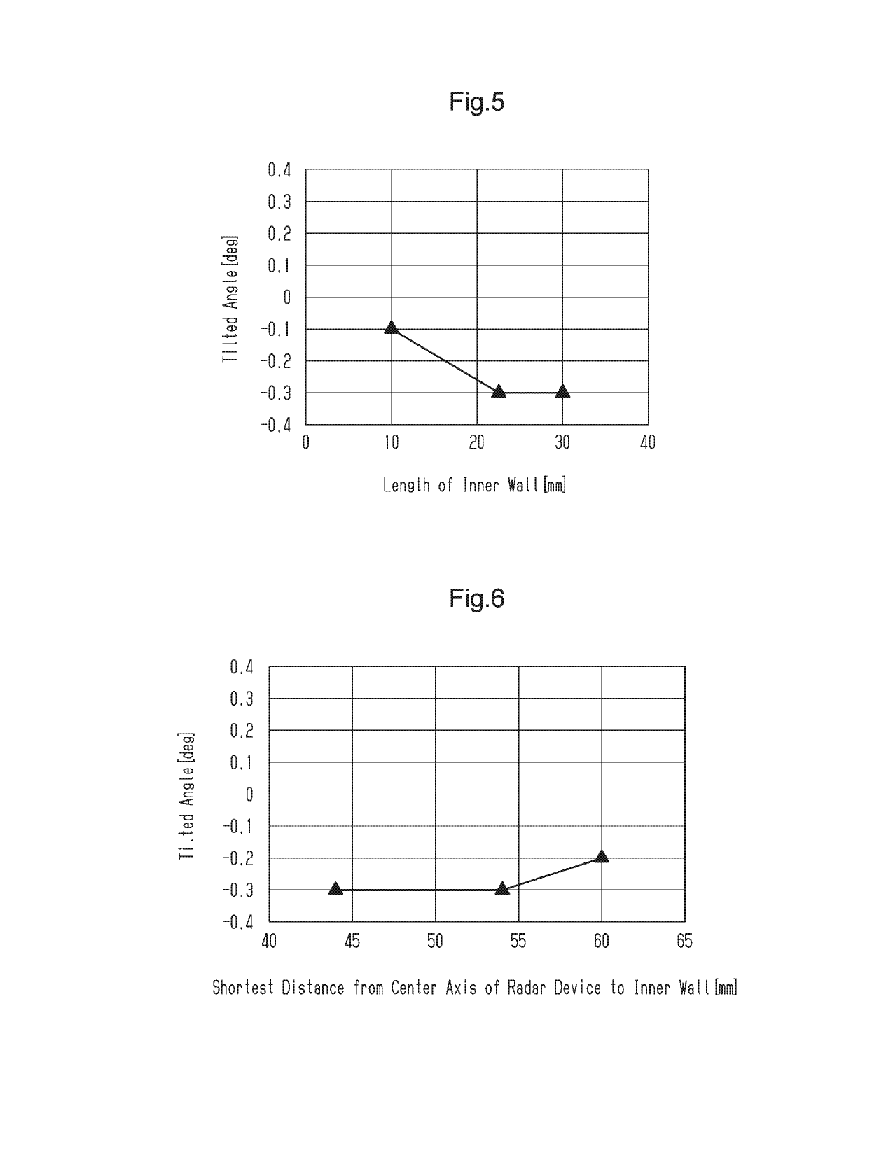

The graph in FIG. 5 illustrates changes in the tilted angle θ2 of the main lobe ML emitted from the radar device 11 when the length L is changed. The measured tilted angles θ2 are each less than or equal to 0.38°in absolute value. Further, when the length L is less than 20 mm, the tilted angle θ2 becomes closer to 0°. A decrease in the length L decreases the area acting as the reflection surface in the inner wall 34. A decrease in the length L may, however, result in insufficient accommodation space S in the accommodation portion 37 for accommodation of the light sources 20. This situation will become particularly prominent when the length L is set to less than 15 mm. Thus, to provide sufficient accommodation space S in the accommodation portion 37, it is preferred that the length L be greater than or equal to 15 mm. Further, an increase in the length L will enlarge the housing 30 in the longitudinal direction X. This may result in interference of the housing 30 with components (not shown) located behind the radar unit 10 in the longitudinal direction X. This situation will become particularly prominent when the length L is greater than 20 mm and more prominent when the length L is greater than 27 mm. Accordingly, to reduce the size of the housing 30 in the longitudinal direction X, it is preferred that the length L be less than or equal to 27 mm and more preferable that the length L be less than or equal to 20 mm. In the present embodiment, the length L is set to 22 mm.

The graph in FIG. 6 illustrates changes in the tilted angle θ2 of the main lobe ML emitted from the radar device 11 when the shortest distance D2 is changed. The measured tilted angles θ2 are each less than or equal to 0.38° in absolute value. When the shortest distance D2 is greater than 54 mm, the tilted angle θ2 becomes closer to 0°. An increase in the shortest distance D2 decreases the area of a portion of the inner wall 34 acting as a wave-incident surface (reflection surface) of the side lobe SL. As the shortest distance D2 increases, however, the housing 30 will have to be enlarged radially outward to obtain enough accommodation space S in the accommodation portion 37 for accommodation of the light sources 20. This situation becomes particularly prominent when the shortest distance D2 is greater than 65 mm. Thus, to reduce the size of the housing 30 in the radial direction, it is preferred that the shortest distance D2 be less than or equal to 65 mm. A decrease in the shortest distance D2 will decrease the radial size of the housing 30 but reduce the view angle of the radar device 11. This situation becomes particularly prominent when the shortest distance D2 is less than 54 mm and further prominent when the shortest distance D2 is less than 40 mm. Thus, to obtain a sufficient view angle for the radar device 11, it is preferred that the shortest distance D2 be greater than or equal to 40mm and more preferable that the shortest distance D2 be greater than or equal to 54 mm. In the present embodiment, the shortest distance D2 is 40 mm.

### Operation of Present Embodiment

As shown in FIG. 3, the radar device 11 is located at a position separated from the bottom wall 31 of the housing 30 in the longitudinal direction X and separated from the inner wall 34 of the accommodation portion 37 of the housing 30 in the orthogonal direction, which is parallel to the imaginary plane V. Thus, no restrictions are imposed on the size and arrangement of the radar device 11. This improves the degree of design freedom in size and arrangement of the radar device 11.

The side lobes SL emitted from the radar device 11 and reflected by the inner wall 34 may lower the accuracy of the radar device 11 when interfering with the main lobe ML emitted from the radar device 11 and causing a beam tilt. In this regard, the vehicle radar unit 10 of the present embodiment is formed so that the inclination angle θ1 is 3°, the length L is 22 mm, and the shortest distance D2 is 40 mm. As a result, even if the side lobes SL emitted from the radar device 11 reflected by the inner wall 34 interferes with the main lobe ML, the tilted angle θ2 with respect to the central axis C of the main lobe ML will be limited to less than or equal to 0.38° in absolute value. This avoids reduction in the accuracy of the radar device 11 that would be caused by a beam tilt of the main lobe ML.

### Advantages of Present Embodiment

The vehicle radar unit 10 includes the radar device 11 and the exterior member 12, which has millimeter wave transmissivity. The exterior member 12 includes the light sources 20, the housing 30 which includes the opening 38, and the cover 40 which covers the opening 38 and has visible light transmissivity. The housing 30 includes the bottom wall 31 and the outer wall 36 that extends forward from the edge of the bottom wall 31. The bottom wall 31 includes the projection 32. The projection 32 projects away from the radar device 11. The projection 32 and the outer wall 36 form the accommodation portion 37, which accommodates the light sources 20. The radar device 11 is located at a position separated from the inner wall 34 in the orthogonal direction, which is orthogonal to the central axis C extending through the central portion of the radar device 11. The inclination angle θ1 of the inner wall 34 with respect to the central axis C, the length L of the inner wall 34 in the longitudinal direction X, and the shortest distance D2 from the central axis C to the inner wall 34 are set so that the absolute value of the tilted angle θ2 with respect to the central axis C of the main lobe ML emitted from the radar device 11 is less than or equal to 0.38°.

This structure increases the accuracy of the radar device 11, while improving the degree of design freedom of the radar device 11.

The inclination angle θ1 of the inner wall 34 with respect to the central axis C is set to 3°.

When decreasing the inclination angle θ1 of the inner wall 34 to less than 1°, the tilted angle θ2 of the main lobe ML tends to become greater than 0.38°. This may lower the accuracy of the radar device 11. In this regard, the inclination angle θ1 of the inner wall 34 in the above structure is greater than or equal to 1°. This limits the tilted angle θ2 of the main lobe ML to less than or equal to 0.38° in absolute value.

Further, an increase in the inclination angle θ1 of the inner wall 34 decreases the angle of incidence of the side lobe SL entering the inner wall 34. This decreases the reflection angle of the side lobe SL reflected by the inner wall 34. In this case, as the transmission component of the side lobe SL passing through the inner wall 34 becomes larger, the reflection component of the side lobes SL reflected by the inner wall 34 becomes smaller. This decreases the tilted angle θ2 of the main lobe ML in absolute value. An increase in the inclination angle θ1 of the inner wall 34 will enlarge the size of the housing 30 radially outward to obtain sufficient accommodation space S in the accommodation portion 37 for accommodation of the light sources 20. This situation becomes particularly prominent when the inclination angle θ1 of the inner wall 34 is greater than 12°. In this regard, the inclination angle θ1 of the inner wall 34 is less than or equal to 12° in the above structure. This reduces the size of the housing 30 while avoiding the occurrence of a beam tilt of the main lobe ML.

Accordingly, the accuracy of the radar device 11 is improved without enlarging the housing 30.

The length L of the inner wall 34 in the longitudinal direction X is set in a range between 15 mm and 20 mm, inclusive.

An increase in the length L of the inner wall 34 increases the area of a portion of the inner wall 34 acting as a reflection surface of the side lobe SL. This increases the amount of the side lobe SL reflected by the inner wall 34. In this case, the tilted angle θ2 of the main lobe ML in absolute value is likely to increase. Further, an increase in the length L of the inner wall 34 will enlarge the housing 30 in the longitudinal direction X. Thus, the radar unit 10 may interfere with the members located behind the radar unit 10 in the longitudinal direction. Such a situation becomes particularly prominent when the length L of the inner wall 34 is set to greater than 20 mm. In this regard, the length L of the inner wall 34 is less than or equal to 20 mm in the above structure. This reduces the size of the housing 30, while limiting the tilted angle θ2 of the main lobe ML to less than 0.38° in absolute value.

Further, a decrease in the length L of the inner wall 34 decreases the area of a portion of the inner wall 34 that serves as a reflection surface of the side lobe SL. This decreases the amount of the side lobes SL reflected by the inner wall 34 and allows the tilted angle θ2 of the main lobe ML to be decreased in absolute value. A decrease in the length L of the inner wall 34 will result in insufficient accommodation space S in the accommodation portion 37 for accommodation of the light sources 20. This situation becomes particularly prominent when the length L of the inner wall 34 is set to less than 15 mm. In this regard, the length L of the inner wall 34 is greater than or equal to 15 mm in the above structure. Thus, sufficient accommodation space S is obtained in the accommodation portion 37, while limiting the beam tilt of the main lobe ML.

Therefore, the accuracy of the radar device 11 is further improved while obtaining sufficient accommodation space S in the accommodation portion 37 without enlarging the housing 30.

The shortest distance D2 from the central axis C to the inner wall 34 is set in a range between 54 mm and 65 mm, inclusive.

A decrease in the shortest distance D2 from the central axis C to the inner wall 34 increases the area of the portion of the inner wall 34 acting as the reflection surface of the side lobe SL. This increases the amount of the side lobe SL reflected by the inner wall 34. As a result, the tilted angle θ2 of the main lobe ML in absolute value tends to increase. Further, a decrease in the shortest distance D2 reduces the size of the projection 32 in the direction toward the central axis C. As a result, for example, the view angle of the radar device 11 is reduced. This situation is particularly prominent when the shortest distance D2 is set to less than 54 mm. In this regard, the shortest distance D2 is greater than or equal to 54 mm in the above structure. This provides a sufficient view angle for the radar device 11, while limiting the tilted angle θ2 of the main lobe ML to the absolute value of less than 0.38°.

Further, an increase in the shortest distance D2 decreases the area of the portion of the inner wall 34 that acts as the reflection surface of the side lobe SL, and thus decreases the amount of the side lobe SL reflected by the inner wall 34. Accordingly, the tilted angle θ2 of the main lobe ML in absolute value is decreased. An increase in the shortest distance D2, however, will result in enlargement of the housing 30 in the direction extending away from the central axis C to obtain sufficient accommodation space S in the accommodation portion 37 for accommodation of the light sources 20. This situation becomes particularly prominent when the shortest distance D2 is set to greater than 65 mm. In this regard, the shortest distance D2 is less than or equal to 65 mm in the above structure. This reduces the size of the housing 30 while limiting beam tilt of the main lobe ML.

Therefore, the accuracy of the radar device 11 is further improved, without enlarging the housing 30.

### Modifications

The present embodiment may be modified as follows. The present embodiment and the following modifications can be combined as long as the combined modifications remain technically consistent with each other.

The end portion 33 does not need to be inclined with respect to the vertical direction Z as exemplified in the present embodiment, and may be flat and extend in the lateral direction W and the vertical direction Z.

The exterior member 12 does not have to include the panel 16 that does not have any air passages like in the above embodiment. Instead of the panel 16, the exterior member 12 may include, for example, a front grille that has an air passage.

The exterior member related to the present disclosure does not have to include the emblem 13 and the panel 16 like in the above embodiment. For example, the exterior member may include only the emblem 13.

The vehicle radar unit related to the present disclosure does not have to be attached to the front portion of the vehicle like in the above embodiment. For example, as long as the exterior member is arranged in front of the radar device 11 in the emitting direction of the millimeter waves, the vehicle radar unit may be attached to the rear portion of the vehicle or to the side portion of the vehicle. In this case, the exterior member may form the exterior body at the rear or the side of the vehicle.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A vehicle radar unit, comprising:
a radar device configured to emit and receive electromagnetic waves; and
an exterior member, having electromagnetic wave transmissivity, arranged in front of the radar device in an emitting direction of the electromagnetic waves, wherein
the exterior member includes a light source configured to emit visible light, a housing including an opening that is open frontward in the emitting direction, and a cover having visible light transmittivity and covering the opening,
the housing includes a bottom wall and an outer wall extending frontward in the emitting direction from an edge of the bottom wall,
the bottom wall includes a projection projecting in the emitting direction and separated from the radar device, the projection and the outer wall forming an accommodation portion for accommodation of the light source,
the projection includes an inner wall extending rearward in the emitting direction from an edge of a projection end,
the radar device is located at a position separated from the inner wall in a direction orthogonal to a central axis extending in the emitting direction through a center of the radar device, and
an inclination angle of the inner wall with respect to the central axis, a length of the inner wall in the emitting direction, and a shortest distance from the central axis to the inner wall are set so that a tilted angle of a main lobe of the electromagnetic waves emitted from the radar device with respect to the central axis is greater than 0° and less than or equal to 0.38° in absolute value.

2. The vehicle radar unit according to claim 1, wherein the inclination angle of the inner wall with respect to the central axis is set in a range between 1° and 12°, inclusive.

3. The vehicle radar unit according to claim 1, wherein the length of the inner wall in the emitting direction is set in a range between 15 mm and 20 mm, inclusive.

4. The vehicle radar unit according to claim 1, wherein the shortest distance from the central axis to the inner wall is set in a range between 54 mm and 65 mm, inclusive.
